(19) United States
(12) Patent Application Publication
(10) Pub. No.: US 2023/0294613 A1
(43) Pub. Date: Sep. 21, 2023

(54) Releasable Attachment Device

(71) Applicant: Kuat Innovations LLC, Springfield, MO (US)

(72) Inventors: Luke Kuschmeader, Springfield, MO (US); Jordan Bowles, Lexington, SC (US)

(73) Assignee: Kuat Innovations LLC, Springfield, MO (US)

(21) Appl. No.: 18/185,471

(22) Filed: Mar. 17, 2023

Related U.S. Application Data
(60) Provisional application No. 63/320,985, filed on Mar. 17, 2022.
(60) Provisional application No. 63/325,272, filed on Mar. 30, 2022.

(51) Int. Cl. B60R 9/00; B60R 11/00

(52) U.S. Cl. CPC B60R 9/00; B60R 11/00; B60R 2011/0052

(57) ABSTRACT

A releasable attachment device for mounting a component to a t-slot or similar channel includes an actuator for latching, unlatching, and disengaging a bolt from the t-slot or similar channel. In the latched configuration the releasable attachment device secures the component to the t-slot. The actuator may comprise a lever for rotating a cam mechanism on a first axis. The rotation of the cam mechanism translates a bolt from a latched position to an unlatched position. The actuator may rotate in a second axis to rotate the bolt from an unlatched position to a disengaged position. In the disengaged position the releasable attachment device may be removed from the t-slot. The device may have an adjustment bolt to adjust the device to secure to different sizes of t-channels.

### CROSS-REFERENCE TO RELATED APPLICATIONS

This application claims the benefit of U.S. Provisional Patent Application No. 63/320,985 filed on Mar. 17, 2022, and U.S. Provisional Patent Application No. 63/325,272 filed on Mar. 30, 2022.

### BACKGROUND

### Field of the Invention

This disclosure is in the field of devices for attaching or fastening an automotive component to another component or piece of equipment such as a vehicle or vehicle crossbar. More specifically, this disclosure is in the field of mounting systems for attaching components to rails and channels on vehicles or vehicle crossbars. More particularly, this disclosure is in the field of quick release mounting systems for rails and channels on vehicles or vehicle crossbars.

### Description of the Related Art

Rails with channels or slots are commonly provided on cargo racks, vehicles, and other pieces of equipment to allow attachment of components to the cargo rack or piece of equipment. Often the channels or slots have a T-shaped cross-section with for receiving the head of a bolt that is retained in the channel while the shaft of the bolt extends through an aperture or slot to attach to the component.

The insertion of the bolt in the T-slot requires a mechanism for inserting the head of the bolt into the channel such as a wider portion of the slot or access to the end of the channel. These options are not preferable because they may require disassembly of the t-channel rack and limit the ability to add more attachment devices to the channel without removing already installed attachment devices.

Some bolts for use with T-slots are provided with removable heads that remain in the channel when the component is detached from the channel, or asymmetrical heads that fit through the channel slot in one orientation but are retained in the channel in another orientation. In such systems the connection and tightening of the bolt is difficult and time consuming and may require tools to securely tighten the component on the rail.

### SUMMARY OF THE INVENTION

In various embodiments, the releasable attachment device comprises an actuator and a bolt assembly provided on a mount component. The actuator is configured to translate the bolt assembly from a latched configuration to an unlatched configuration, and vice versa, with respect to a t-slot. The actuator is also configured to rotate the bolt assembly from the unlatched configuration to a disengaged configuration, and vice versa. The releasable attachment device may also incorporate a locking mechanism.

In one embodiment, the mount device is used for attachment to a vehicle having a supporting member with a t-channel having t-channel flanges, the mount device comprising a mount body; a bolt assembly attached to the mount body, the bolt assembly comprising a bolt having a shaft and a bolt head configured to extend into the t-channel when the mount body is disposed on the support member, a bolt collar with an aperture for receiving the shaft of the bolt, a cam lever pivotally attached to the bolt collar and configured to pivot with respect to the bolt collar from a latched position to an unlatched position, and an adjustment bolt that attaches the bolt shaft to the bolt collar; wherein the adjustment bolt is configured to adjust the separation of the bolt head from the mount body when the cam lever is in the latched position to match the t-channel flange.

In some embodiments the aperture in the bolt collar and the bolt shaft have at least one matching key face. In various embodiments, the bolt shaft is configured to slide into or out of the aperture in the bolt collar when the adjustment bolt is rotated. In further embodiments the adjustment bolt is inaccessible when the cam lever is in the latched position. The separation of the bolt head from the mount body is adjusted in some of these embodiments to secure the t-channel flange between the bolt head and the mount body when the cam lever is in the latched position. In various embodiments the separation of the bolt head from the mount body is adjusted to alter the force exerted on the t-channel flanges by the bolt head when the cam lever is in the latched position.

In some embodiments of the mount device the bolt assembly is configured to pivot with respect to the mount body from an engaged position to a disengaged position when the cam lever is in the unlatched position; and the mount body further comprises a feature configured to stop pivotal movement of the bolt assembly when it is in the engaged position and the disengaged position. In some embodiments the engaged position is disposed at 90 degrees to the disengaged position. In a preferred embodiment the bolt head is oriented transverse to the t-channel in the engaged position and in line with the t-channel in the disengaged position.

In other embodiments the inventive releasable mount device for attachment to a vehicle having a t-channel slot, comprises a mount body; a bolt assembly rotatably mounted on the mount body, and comprising an actuator and a bolt; the actuator pivotally attached to the bolt by a bolt collar, the actuator configured to move the bolt assembly from a latched position to an unlatched position with respect to the mount body; wherein the bolt is adjustably attached to the bolt collar to allow adjustment of the latched position of the bolt with respect to the mount body.

In some of these embodiments the mount body further comprises a protrusion to stop movement of the actuator when it reaches the latched position or the unlatched position. In varying embodiments, the protrusion limits pivotal movement of the actuator to a 90 degree range between the latched position and the unlatched position.

In some embodiments of the releasable mount device, adjustment of the attachment of the bolt to the bolt collar moves the bolt toward or away from the mount body. In some embodiments the bolt is adjustably attached to the bolt collar by an adjustment bolt. In these embodiments rotation of the adjustment bolt moves the bolt toward or away from the mount body. In some embodiments, the adjustment bolt is configured to translate the bolt head to contact a flange of the t-channel slot when the actuator is in the latched position. Embodiments include some wherein the adjustment bolt is configured to adjust the position of the bolt head to apply a desired force to a flange of the t-channel slot when the actuator is in the latched position.

### BRIEF DESCRIPTION OF THE DRAWINGS

FIG. 1 is a perspective view of a bicycle rack mounted on a crossbar using an embodiment of the releasable attachment device.

FIG. 2 is a perspective view of an embodiment of the releasable attachment device attached to a crossbar.

FIG. 3A is a detailed perspective view of an embodiment of the releasable attachment device in a latched configuration.

FIG. 3B is a detailed perspective view of an embodiment of the releasable attachment device in an unlatched, engaged configuration.

FIG. 3C is a detailed perspective view of an embodiment of the releasable attachment device in a disengaged configuration.

FIG. 4A is a top plan view of an embodiment of the releasable attachment device in a latched configuration.

FIG. 4B is a top plan view of an embodiment of the releasable attachment device in an unlatched, engaged configuration.

FIG. 4C is a top plan view of an embodiment of the releasable attachment device in an unlatched, disengaged configuration.

FIG. 5A is a cross-sectional view of an embodiment of the releasable attachment device in a latched configuration in plane 5-5 depicted in FIG. 4A.

FIG. 5B is a cross-sectional view of an embodiment of the releasable attachment device in an unlatched, engaged configuration in plane 5-5 depicted in FIG. 4A.

FIG. 5C is a cross-sectional view of an embodiment of the releasable attachment device in an unlatched, disengaged configuration in plane 5-5 depicted in FIG. 4A.

FIG. 6A is a perspective exploded view of a bolt assembly of an embodiment of the releasable attachment device.

FIG. 6B is a side exploded view of a bolt assembly of an embodiment of the releasable attachment device.

FIG. 7A is a perspective view of a portion of an embodiment of the releasable attachment device in an unlocked configuration.

FIG. 7B is a perspective view of a portion of an embodiment of the releasable attachment device in a locked configuration.

FIG. 8A is a top view of a portion of an embodiment of the releasable attachment device with a locking mechanism in an unlocked configuration.

FIG. 8B is a top view of a portion of an embodiment of the releasable attachment device with a locking mechanism in a locked configuration.

FIG. 9A is a bottom view of a portion of an embodiment of the releasable attachment device with a locking mechanism in an unlocked configuration.

FIG. 9B is a bottom view of a portion of an embodiment of the releasable attachment device with a locking mechanism in a locked configuration.

FIG. 10A is a perspective view of a portion of an embodiment of the releasable attachment device with a locking mechanism in an unlocked configuration.

FIG. 10B is a perspective view of a portion of an embodiment of the releasable attachment device with a locking mechanism in a locked configuration.

FIG. 11A is a bottom view of a portion of an additional embodiment of the releasable attachment device with a locking mechanism in an unlocked configuration.

FIG. 11B is a bottom view of a portion of an additional embodiment of the releasable attachment device with a locking mechanism in a locked configuration.

### DETAILED DESCRIPTION

The inventive releasable attachment device provides a mechanism for quickly attaching and detaching a functional component, such as a bicycle rack, to and from a channel or t-slot provided on a cargo rack, vehicle, trailer, or other piece of equipment. The inventive device may be used in varying embodiments on any type of equipment including cargo racks, rooftop tents, truck bed racks, integrated truck or car attachment systems, vehicle crossbars, recreational vehicles, and racks for the same, fixed equipment racks for use in buildings, storage racks of all types, and also bicycles, motorcycles, and any other piece of equipment that may be provided with a channel or t-slot for the attachment of another component or piece of equipment.

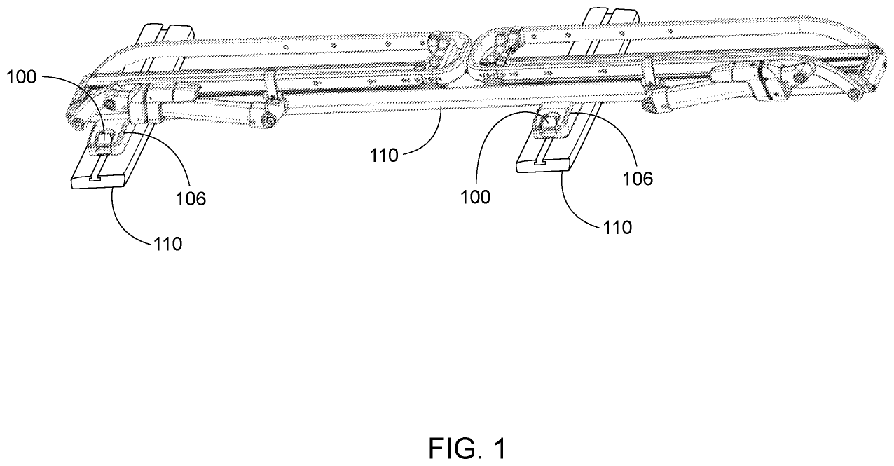

In the depicted embodiments the inventive attachment devices are incorporated into a mount component 106. When using this embodiment, the mount component 106 may be attached to the actual equipment or functional component to be held in place by the release attachment device. For example, the mount component may be bolted to a bicycle rack, ski rack, kayak rack, or other type of rack for carrying recreational equipment on a motor vehicle. In other embodiments the inventive attachment device may be incorporated into such a rack so that no separate mount component is necessary. FIG. 1 depicts two of the mount components 106 attached to vehicle crossbars 110 using the releasable attachment device 100. The mount 106 secures bicycle rack 112 (a functional component) to the crossbars 110. References to the mount component 106 herein also shall be deemed to refer to a piece of equipment into which the attachment device 100 has been integrated, for example a kayak rack, ski rack, bicycle rack, rooftop tent, or cargo box that has one or more embodiment of release attachment device 100 built into the tent or box.

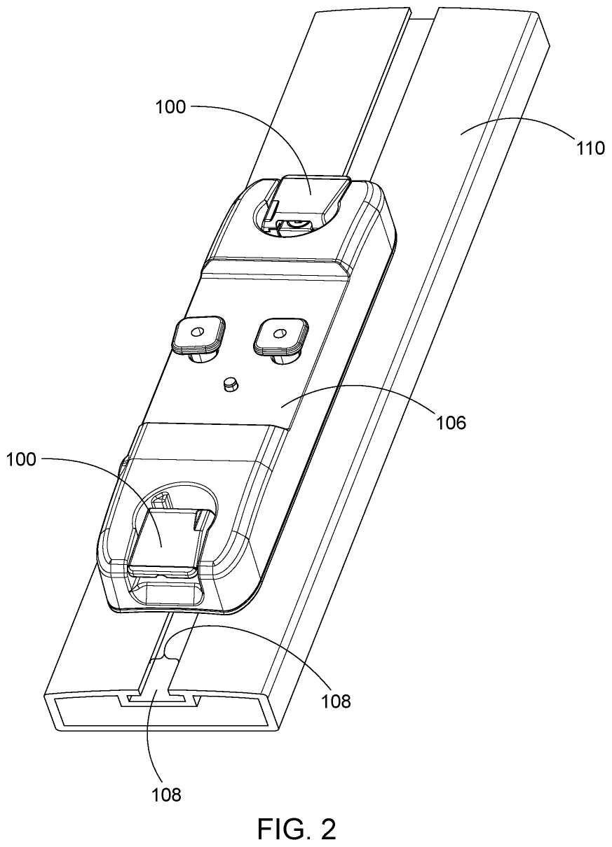

FIG. 2 depicts an embodiment of a mount component 106 from FIG. 1 with the bicycle rack 112 removed for clarity. This embodiment has two apertures 106a for receiving two of the releasable attachment devices 100 to secure mount 106 to the t-channel 108 in the crossbar 110.

In the depicted device, two of the inventive attachment devices 100 are incorporated into the mount component 106. In some uses of the inventive attachment device 100 only a single attachment device 100 is provided to attach the functional component 112 to the channel. For example, a grab handle, shovel mount, or similar functional component may have a single integrated embodiment of the inventive attachment device 100 for attachment to a roof rack or a cargo rack for a truck bed or another t-channel rack system.

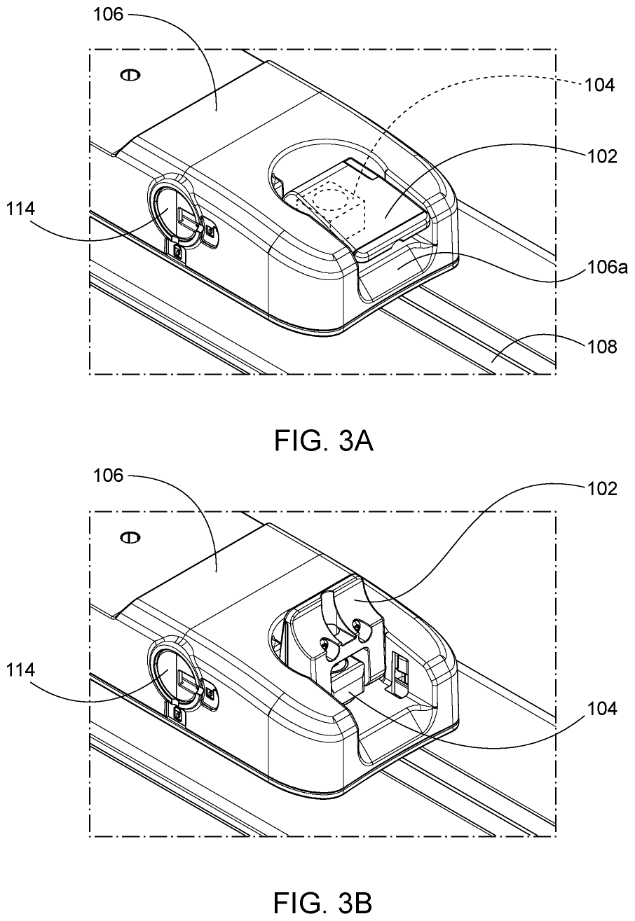

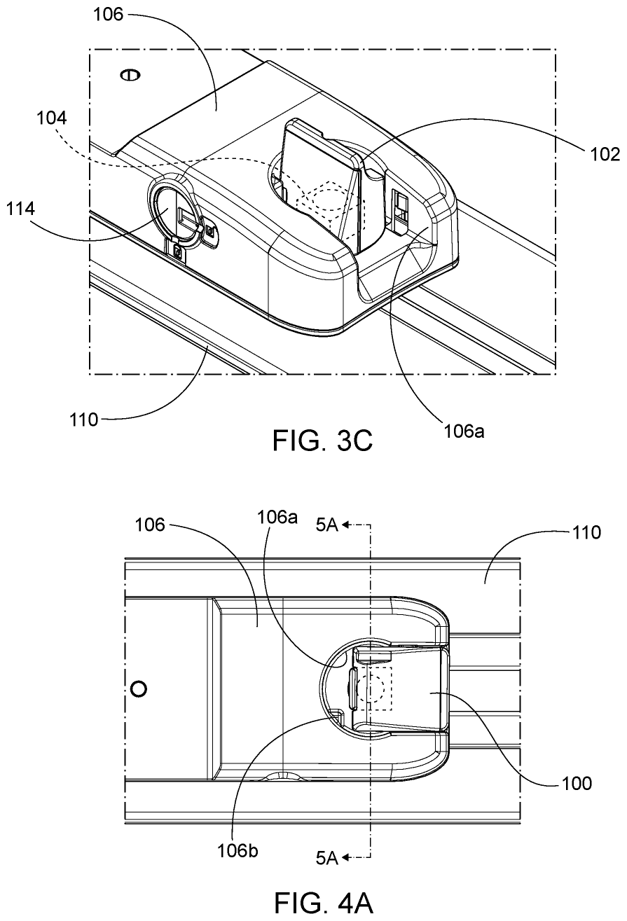

Referring to FIG. 3A, an embodiment of the inventive attachment device 100 is depicted in a latched configuration. FIG. 3B depicts the same embodiment in the unlatched, engaged configuration. FIG. 3C depicts the same embodiment in the unlatched, disengaged configuration. In this embodiment the device 100 is provided with an actuator 102 for manipulation by a user to latch, unlatch, and disengage the attachment device 100. In this embodiment the actuator 102 comprises a lever that delivers a camming action to bolt assembly 104 when it is rotated vertically from the latched configuration (FIG. 3A) to the unlatched configuration (FIG. 3B). The camming action translates the bolt head 104a inwardly into the t-channel releasing clamping pressure on the t-channel flanges, as is shown in more detail in later figures.

The actuator 102 may then be rotated horizontally to the disengaged position depicted in FIG. 3C. Horizontal rotation of the actuator 102 from the latched (but still engaged) position to the disengaged position also rotates the bolt assembly 104 into the disengaged configuration at which point the device 100 may be removed from the t-slot or t-channel 108.

In this embodiment the actuator 102 is disposed in a cavity 106a in the mount component 106. In some embodiments the upper surface of the actuator 102 is flush with or all or partially below the upper surface of the mount component 106 in the latched configuration. In other embodiments actuator 102 may be disposed on top or above the upper surface of the mount component 106. In varying embodiments, the actuator 102 may comprise one component or several subcomponents.

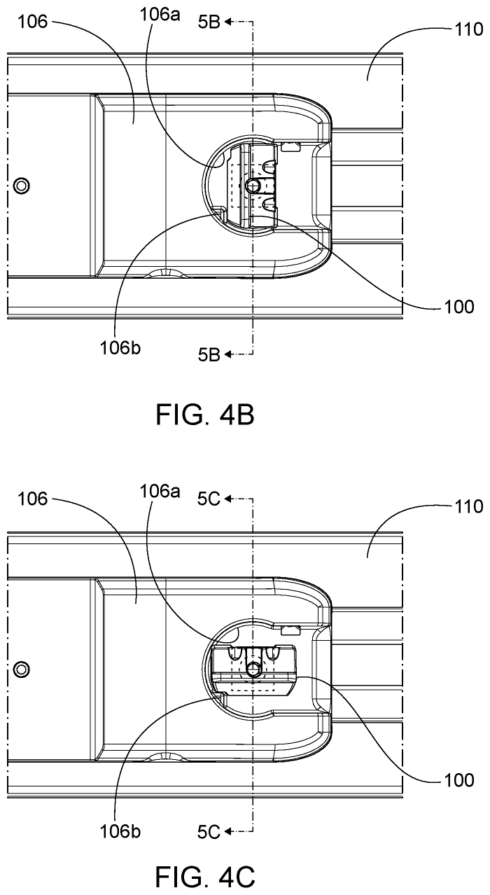

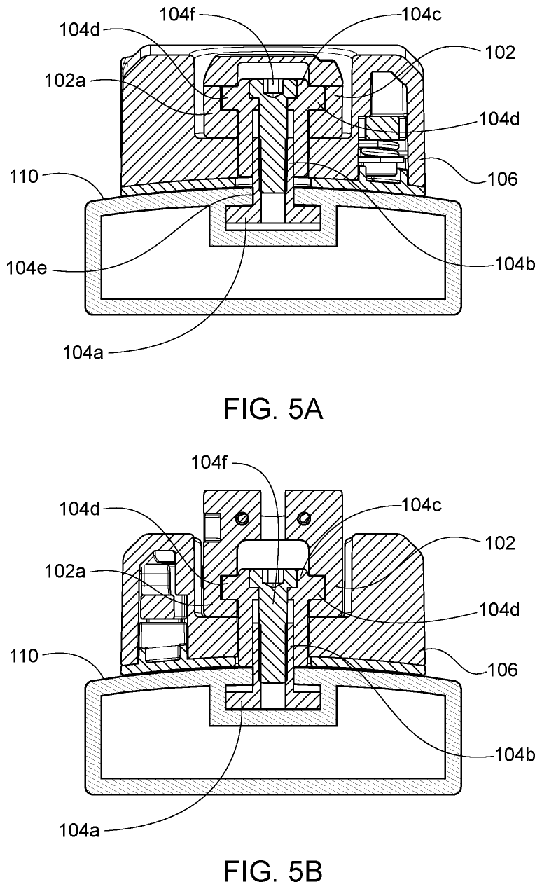

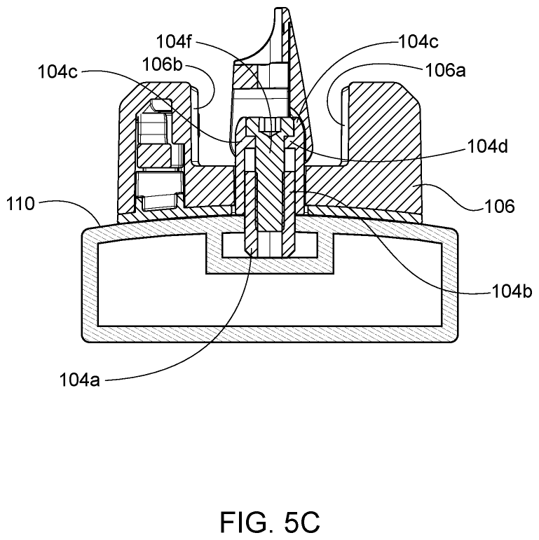

FIGS. 4A, 4B, and 4C depicts a top view of a mount 106 with the releasable attachment device 100 in, respectively (i) a latched configuration, (ii) an unlatched, engaged configuration, and (iii) an unlatched, disengaged configuration. FIGS. 5A, 5B, and 5C are cross-sectional views of this embodiment in the same three configurations, respectively, on the 5-5 axis depicted in FIG. 4A.

In embodiments of the attachment device 100, the actuator 102 is configured to vertically translate the bolt assembly 104 (along the longitudinal axis of its shaft 104b) when the actuator 102 moves from the latched to the unlatched configuration, and vice versa. This can be seen in the movement of the bolt assembly 104 between FIGS. 5A and 5B. The bolt 104 may comprise an assembly of subcomponents, as in the case of the depicted embodiment. In other embodiments, the bolt 104 may be a single component or may comprise subcomponents such as those incorporated in the depicted embodiment. In the depicted embodiment the bolt assembly 104 comprises a retention member/bolt bead 104a, a bolt shaft 104b, a cam follower/bolt collar 104c, and pivot arms 104d. The bolt assembly 104 in the depicted embodiment further comprises a shoulder 104e disposed adjacent the bolt shaft 104b. In some embodiments the bolt shaft 104b may be a keyed shaft by having features such as the flat surfaces 104g. “Vertical translation” of the bolt means translation of the bolt along the longitudinal axis running from the retention member 104a on one end and the cam follower 104c on the other end.

The retention member 104a may vary in embodiments of the device 100. For example, it may comprise a nut threaded onto the shaft 104b, or flanges that extend outwardly from the shaft 104b, a head formed on the shaft 104b, thicker portions of the shaft 104b, or other similar structures. It may comprise a flat plate or have a curved profile or protrusions to more securely engage the flanges 108c of the slot 108 when the device 100 is engaged on the slot 108.

In varying embodiments, the retention member 104a is an asymmetric shape that may pass through the slot 108a in one orientation (disengaged configuration) such as shown in FIG. 5C but is not able to pass through the slot 108a in a second engaged orientation (unlatched or latched configurations) such as that shown in FIG. 5B. In the depicted embodiment, the retention member 104a has a nominal narrow dimension that is smaller than the nominal width of slot 108a, and a nominal wide dimension that is greater than the nominal width of slot 108a. In this embodiment the wide dimension of the retention member 104a is disposed perpendicularly to the narrow dimension thereof, though it need not always be perpendicular. This allows the retention member 104a to be inserted through the slot 108a in the disengaged configuration (see FIG. 5C), turned substantially 90 degrees to the unlatched configuration (FIG. 5B), and in such orientation, it will be loosely retained in the slot 108a. The actuator 102 is then used to vertically translate the bolt 104 to the latched configuration and applying a clamping force to secure the device 100 in place on the t-slot 108 as shown in FIG. 5A.

The shaft 104b of the bolt assembly 104 extends from the retention member 104a through the slot 108a and then is connected to the cam follower member 104c. In the depicted embodiment, the cam follower member 104c acts as follower that is vertically translated by the camming action of actuator 102. In this embodiment the bolt follower member 104c comprises a cap or collar (optionally keyed) that is attached to the bolt shaft 104b by a screw or bolt 104f. In this embodiment the camming/following action is provided by the interaction of the pivot arms 104d extending from the follower 104c with the actuator 102. As shown by FIG. 5B, turning bolt or machine screw 104f will adjust the position of retention member/t-nut 104a vertically with respect to cam follower 104c.

The rotation of the actuator lever 102a activates a cam portion or mechanism 102b to pull the retention member 104a into contact with the interior surfaces of the flanges or lips 108c of the t-slot 108a. The translation of the retention member 104a squeezes the flanges 108c between the retention member 104a and the mount component 106 with sufficient force to secure the mount component 106 to the channel 108 at a desired position. In the depicted embodiment the camming action is provided by the lever 102a rotating the cam portion 102b. The pivot arms 104d of follower 104c are disposed at or near the termination of slots 102c. The difference in distance between the slot 102c and first camming surface 102d, and the distance between the slot 102c and the second camming surface 102e forces the bolt assembly 104 to translate vertically from an extended (unlatched) configuration to a retracted (latched) configuration, respectively, and back. Other implementations of a cam and follower mechanism may be used in other embodiments of the device 100. The adjustment bolt 104f may be rotated to adjust the position of the bolt head 104b for different thicknesses of flange 108c as needed.

In some embodiments a shoulder 104e is provided adjacent to the retention member 104a. The edge of the shoulder 104e may contact an internal side wall 108d of some t-slot/channel member to prevent rotation of the bolt assembly 104 past the correct latching alignment in one rotational direction, and past the correction alignment for removing the retention member 104a from the t-slot 108a in the other direction. In some embodiments the side walls of cavity 106a may incorporate one or more protrusions 106b to contact the actuator 102 or bolt 104 to stop rotation thereof at desired positions for latching, unlatching, disengaging, and removing device 100 to and from t-slot 108a. In some embodiments, in the latched configuration the side walls of cavity 106a prevent undesired rotation of the bolt assembly 104 when the lever 102a is in the latched configuration. In some embodiments the pivot arms 104d may have a teardrop cross-section to further provide limits on the rotation of the actuator 102 in vertical direction from latched to unlatched configurations.

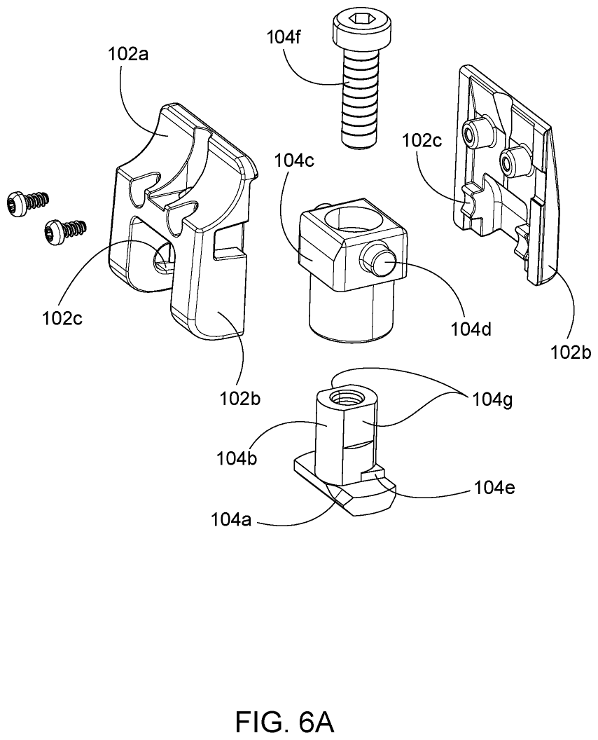

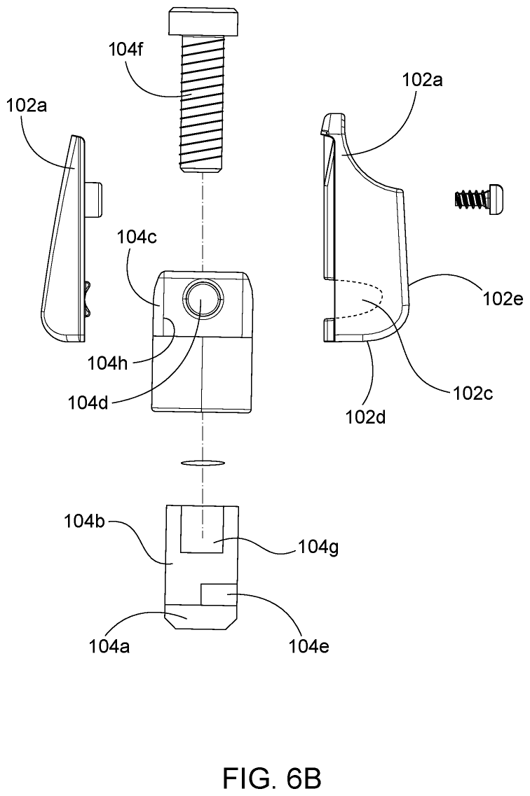

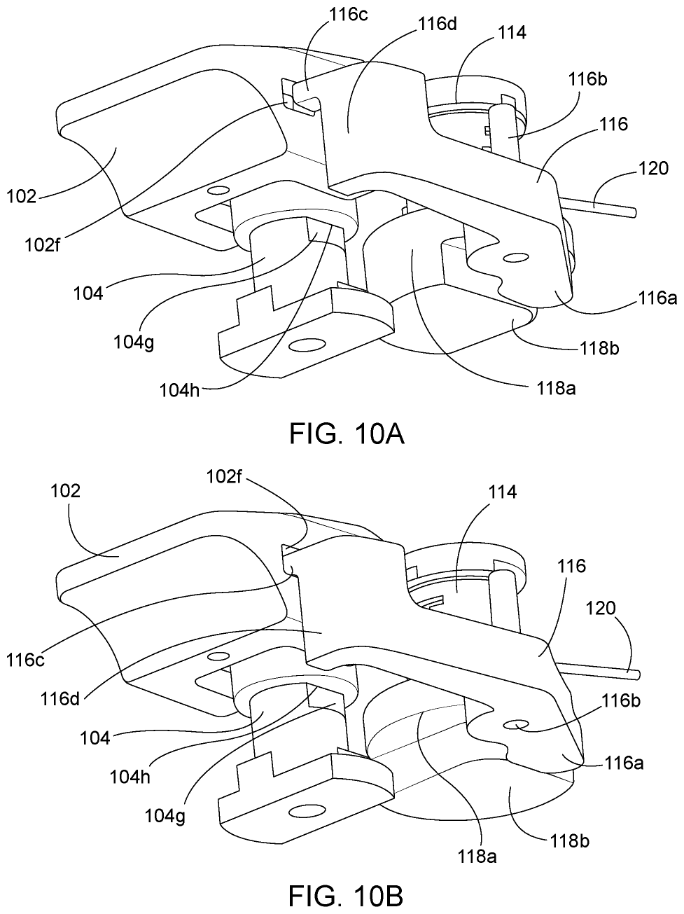

FIGS. 6A and 6B depict embodiments of the bolt assembly 104 in exploded views. In these views the keyed faces 104g of bolt shaft 104b are visible, and the aperture in bolt shaft 104b for receiving the adjustment bolt 104f for adjusting the distance from the bolt head from the camming faces 102d and 102e of the actuator 102. The teardrop shape of this embodiment of pivot arms 104d is clearly visible. The aperture in bolt collar 104c may also have keyed surfaces to match the bolt shaft, which are visible in the embodiment depicted in FIG. 10A.

In some embodiments, a lock 114 is provided on the mount component 106. The lock 114 may be adjacent to the inventive releasable attachment device 100 to (i) prevent rotation or other movement of the actuator 102, (ii) prevent rotation of the bolt 104, or (iii) otherwise prevent removal of the retention member/bolt assembly 104 from the t-slot 108a. In other embodiments the lock 114 may not interact with the inventive device 100 but may directly lock the mount component to the t-slot 108a independently of the device 100. For example, the lock mechanism 114 may rotate a device similar to retention member 104a that is retained in the slot 108a in a first orientation but may be removed from the slot 108a in a second orientation.

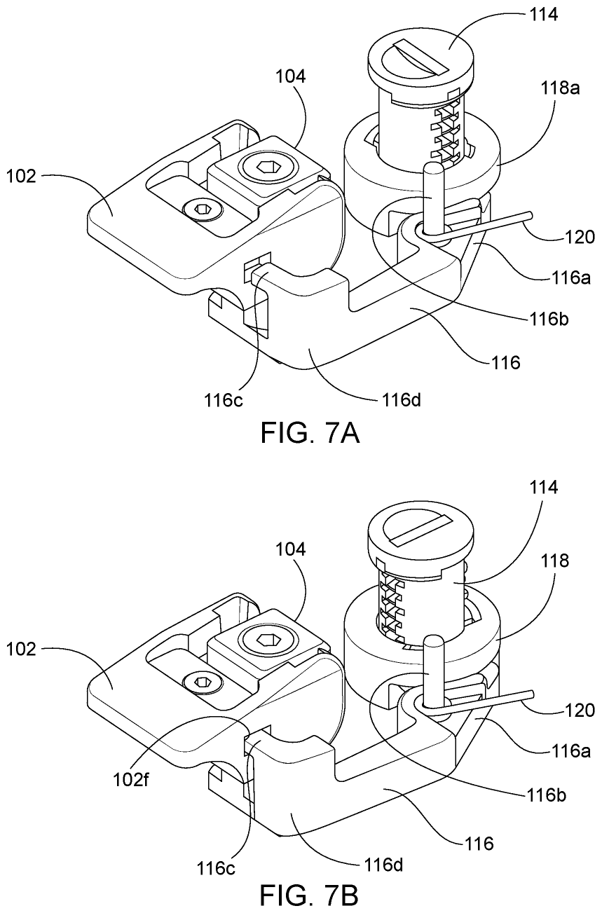

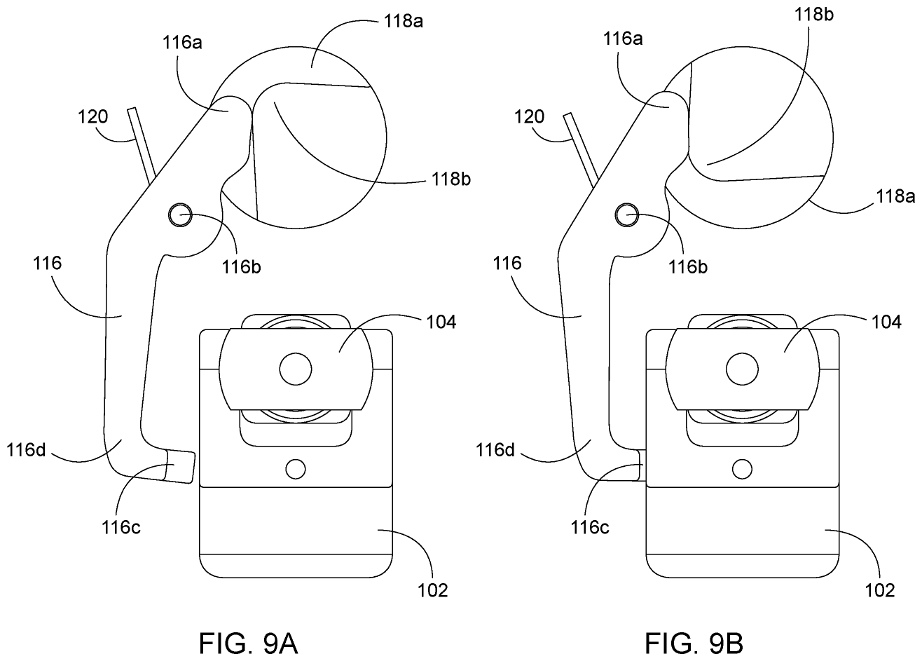

An embodiment of a locking mechanism that prevents rotation of actuator 102 is depicted in FIGS. 7A through 10B, inclusive. In the embodiment depicted in those figures, the lock core 114 is connected to a lock cam 118 for engaging and disengaging a lock lever 116 to secure the actuator 102 in a latched configuration. In the locked configuration in this embodiment a user cannot move the actuator 102 from the latched position to the unlatched or disengaged configurations.

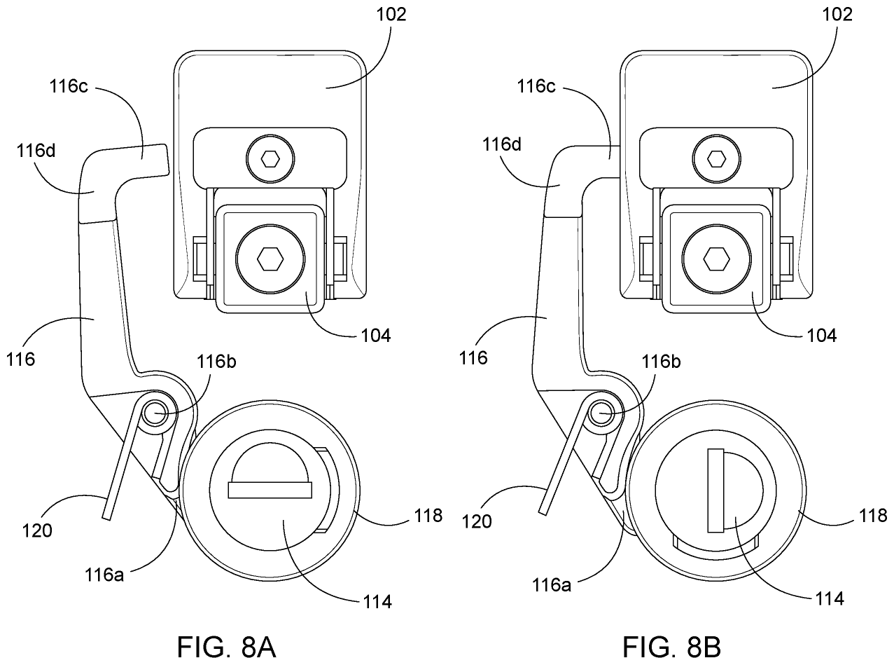

This embodiment of the lock mechanism has a cam 118 with a body or shaft 118a having at least one lobe 118b that rotates or turns as the lock core 114 is turned by a user. The cam 118 interacts with a lock lever 116 to lock and unlock the actuator 102. The lobe 118b may have a cam surface that is a side surface of all or a portion of the cam body 118a as shown in FIGS. 8A through 10B, or from the end of cam as further described below. The lock core 114 may be positioned vertically or horizontally in different embodiments.

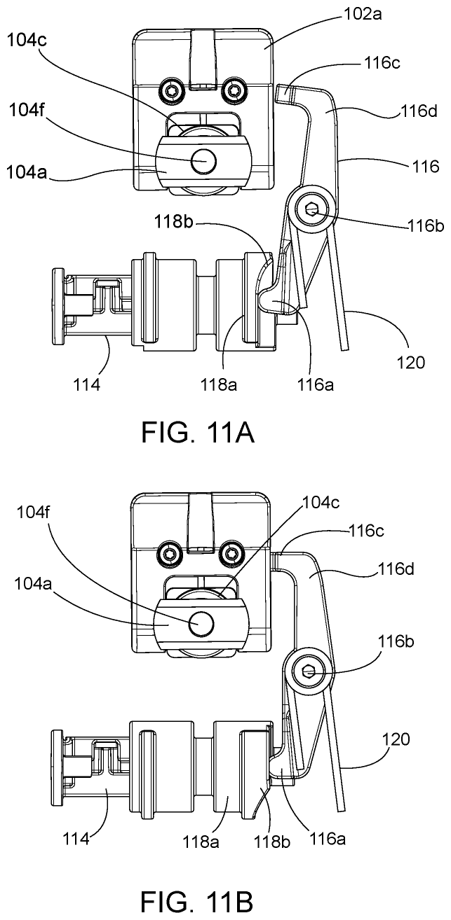

In the embodiment in FIGS. 7A through 10B the lock lever 116 is pivotally mounted to the mount body 106 at a pivot axis or pin 116b. A cam follower 116a portion of the lever 116 interacts with cam surface of the lobe 118b to follow movement of the lobe 118a and pivot the lever 116 from the locked configuration to the unlocked configuration, and vice versa. In the embodiment depicted in FIGS. 7A through 10B the cam surface is on the side of lobe 118b on cam body 118a, but in other embodiments the lock core 114 may be positioned 90 degrees with respect to its position in the depicted embodiment, and the cam surface is on the “bottom” of the lobe 118b on cam body 118a. One such embodiment is depicted in FIGS. 11A and 11B.

In varying embodiments, the lock lever 116 may be provided with a biasing mechanism 120 to cause cam follower 116a to maintain contact with the lobe 118b, or to bias the lock lever 116 toward the locked position or the unlocked position. In the depicted embodiment, the biasing mechanism 120 is a spring that exerts a force on the lock lever 116 to move it to the unlocked position unless the lobe 118b pushes on cam follower 116a to pivot the lock lever 116 to the locked position and compress or wind the spring. When a user turns the lock core 114 to the unlocked position, the cam 118 rotates the lobe 118b away from the lever 116 and the biasing mechanism 120 pivots the lock lever 116 back to the unlocked position.

In various embodiments, the lock lever 116 further comprises a bolt or latch component 116c configured to insert into a lock cavity or bolt hole 102f on the actuator 102 or to engage other features on the actuator 102 sufficient to prevent its rotation. In the depicted embodiments, when the bolt 116c is inserted into the bolt hole 102f, the actuator 102 may not be moved from the latched configuration to another position, and when the bolt 116c is removed from bolt hole 102f the actuator 102 may be moved to the unlatched and disengaged configurations. The bolt 116c may be attached to an arm 116d component of the lock lever 116 to position the bolt 116c at a desired location with respect to actuator 102.

In another embodiment of the releasable attachment device depicted in FIGS. 11A and 11B, the lock cylinder 114 is disposed horizontally with a cam lobe 118 extending from the bottom of the cylinder 114 to engage a lever arm 116 such as that depicted in FIGS. 7A through 10B. The cam lobe in such embodiments may be protrusions or features that extend substantially parallel to the rotational axis of the lock core 114 but with a varying extension around its circumference such that as the lock core 114 rotates the lobe 118b pushes a cam follower 116a in a horizontal direction that is substantially parallel to the rotational axis of the lock core 114. This lobe shape is depicted in FIGS. 11A and 11B.

The following item lists A, B, and C are illustrative, but not limiting, of embodiments of the inventive device. Features of the following item lists may constitute features of the other item lists. The reference numbers provided in the item descriptions are for ease of reference to the figures and shall not be construed as limiting their subject matter.

A1. An accessory mount for a vehicle having a t-channel (108), the accessory mount comprising a mount body (106), a latch mechanism (100) disposed on the mount body (106), the latch mechanism (100) including a t-bolt (104a) configured to secure the mount body (106) to the t-channel (108), the bolt assembly further comprising an adjustment mechanism (104f) configured to translate the t-bolt (104a) with respect to the mount body (106).

A2. The accessory mount according to A1, wherein the adjustment mechanism (104f) is configured to adjust the t-bolt (104a) to secure the mount body (106) to t-channels (108) having varying effective thicknesses.

A3. The accessory mount according to any of the preceding A items, wherein the adjustment mechanism (104f) is configured to translates the t-bolt (104a) linearly with respect to the mount body (106) when the adjustment mechanism (104f) is rotated.

A4. The accessory mount according to any of the preceding A items, wherein the adjustment mechanism (104f) is configured to translates the t-bolt (104a) linearly with respect to the mount body (106) when the adjustment mechanism (104f) is actuated.

A5. The accessory mount according to any of the preceding A items, wherein the t-bolt (104a) is slidably disposed in the latch mechanism (100).

A6. The accessory mount according to any of the preceding A items, wherein the latch mechanism (100) further comprises a bolt collar (104d) for receiving the t-bolt (104a).

A7. The accessory mount according to any of the preceding A items, wherein the bolt collar (104d) and the t-bolt (104a) have matching keyed faces (104g).

A8. The accessory mount according to any of the preceding A items, wherein rotation of the adjustment mechanism (104f) is configured to slide a shaft (104b) of the t-bolt (104a) into or out of the bolt collar (104c).

A9. The accessory mount according to any of the preceding A items, wherein the effective thickness of the t-channel is the distance from the surface of the vehicle that supports the mount body (106) and the inner surface of the flange of the t-channel (108).

A10. The accessory mount according to any of the preceding A items, wherein the latch mechanism (100) further comprises an actuator (102) for engaging and latching the latch mechanism in the t-channel (108).

A11. The accessory mount according to any of the preceding A items, wherein the latch actuator (102) comprises a cam lever.

A12. The accessory mount according to any of the preceding A items, wherein the latch actuator (102) is configured to translate the bolt collar (104c) to clamp the t-bolt (104a) against the flange of the t-channel (108).

A13. The accessory mount according to any of the preceding A items, wherein the adjustment mechanism (104f) comprises a bolt.

B1. An accessory mount for a vehicle having a t-channel, the accessory mount comprising a mount body (106) and a latch mechanism (100), the latch mechanism further comprising a t-bolt head (104a) slidably attached to the latch mechanism (100) by an adjustment bolt (104f).

B2. The accessory mount of item B1, wherein the latch mechanism further comprises a bolt collar (104c) with an aperture for slidably receiving a shaft (104b) of t-bolt (104a).

B3. The accessory mount of any of the preceding B items, wherein the aperture of the bolt collar (104c) has at least one key face (104g).

B4. The accessory mount of any of the preceding B items, wherein the shaft (104b) of the t-bolt (104a) has at least one key face (104g).

B5. The accessory mount of any of the preceding B items, wherein the adjustment bolt (104f) extends through an aperture in bolt collar (104c) into a threaded aperture in shaft (104b).

B6. The accessory mount of any of the preceding B items, wherein the bolt collar (104c) further comprises at least one cam arms (104d).

B7. The accessory mount of any of the preceding B items, wherein the latch mechanism (100) further comprises an actuator (102).

B8. The accessory mount of any of the preceding B items, wherein the actuator (102) comprises a first cam surface (102d) and a second cam surface (102e).

B9. The accessory mount of any of the preceding B items, wherein the actuator (102) further comprises at least one pivot socket (102c) that receives the at least one cam arms (104d) of the bolt collar (104c).

B10. The accessory mount of any of the preceding B items, wherein actuator (102) may be rotated about the at least one cam arms (104d) from a latched position, with second cam surface (102e) in contact with the mount body (106), to an unlatched position, with the first cam surface (102d) in contact with the mount body (106).

B11. The accessory mount of any of the preceding B items, wherein the first cam surface (102d) is closer to the pivot socket (102c) than the second cam surface (102e).

B12. The accessory mount of any of the preceding B items, wherein rotation of the adjustment bolt (104f) translates t-bolt head (104a) closer to or farther from the second cam surface (102f) of the actuator (102).

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A mount device for attachment to a vehicle having a supporting member with a t-channel having t-channel flanges, the mount device comprising:
a mount body;
a bolt assembly attached to the mount body, the bolt assembly comprising:
a bolt having a shaft and a bolt head configured to extend into the t-channel when the mount body is disposed on the support member,
a bolt collar with an aperture for receiving the shaft of the bolt,
a cam lever pivotally attached to the bolt collar and configured to pivot with respect to the bolt collar from a latched position to an unlatched position, and
an adjustment bolt that attaches the bolt shaft to the bolt collar;
wherein the adjustment bolt is configured to adjust the separation of the bolt head from the mount body when the cam lever is in the latched position to match the t-channel flange.

2. The mount device of claim 1 wherein the aperture in the bolt collar and the bolt shaft have at least one matching key face.

3. The mount device of claim 1 wherein the bolt shaft is configured to slide into or out of the aperture in the bolt collar when the adjustment bolt is rotated.

4. The mount device of claim 3 wherein the adjustment bolt is inaccessible when the cam lever is in the latched position.

5. The mount device of claim 1 wherein the separation of the bolt head from the mount body is adjusted to secure the t-channel flange between the bolt head and the mount body when the cam lever is in the latched position.

6. The mount device of claim 1 wherein the separation of the bolt head from the mount body is adjusted to alter the force exerted on the t-channel flanges by the bolt head when the cam lever is in the latched position.

7. The mount device of claim 1 wherein the bolt assembly is configured to pivot with respect to the mount body from an engaged position to a disengaged position when the cam lever is in the unlatched position; and
the mount body further comprises a feature configured to stop pivotal movement of the bolt assembly when it is in the engaged position and the disengaged position.

8. The mount device of claim 7 wherein the engaged position is disposed at 90 degrees to the disengaged position.

9. The mount device of claim 7 wherein the bolt head is oriented transverse to the t-channel in the engaged position and in line with the t-channel in the disengaged position.

10. A releasable mount device for attachment to a vehicle having a t-channel slot, the quick release mount device comprising:
a mount body;
a bolt assembly rotatably mounted on the mount body, and comprising an actuator and a bolt;
the actuator pivotally attached to the bolt by a bolt collar, the actuator configured to move the bolt assembly from a latched position to an unlatched position with respect to the mount body;
wherein the bolt is adjustably attached to the bolt collar to allow adjustment of the latched position of the bolt with respect to the mount body.

11. The releasable mount device of claim 10, the mount body further comprising a protrusion to stop movement of the actuator when it reaches the latched position or the unlatched position.

12. The releasable mount device of claim 10 wherein the mount body further comprises a protrusion to limit pivotal movement of the actuator to a 90 degree range between the latched position and the unlatched position.

13. The releasable mount device of claim 10 wherein adjustment of the attachment of the bolt to the bolt collar moves the bolt toward or away from the mount body.

14. The releasable mount device of claim 10 wherein the bolt is adjustably attached to the bolt collar by an adjustment bolt.

15. The releasable mount device of claim 14 wherein rotation of the adjustment bolt moves the bolt toward or away from the mount body.

16. The releasable mount device of claim 15, wherein the adjustment bolt is configured to translate the bolt head to contact a flange of the t-channel slot when the actuator is in the latched position.

17. The releasable mount device of claim 15, wherein the adjustment bolt is configured to adjust the position of the bolt head to apply a desired force to a flange of the t-channel slot when the actuator is in the latched position.

18. A releasable mount device for attachment to a vehicle having a t-channel slot, the quick release mount device comprising:
a mount body;
a bolt assembly rotatably mounted on the mount body, and comprising an actuator and a bolt;
the actuator pivotally attached to the bolt by a bolt collar, the actuator configured to move the bolt assembly from a latched position to an unlatched position with respect to the mount body;
the mount body further comprising a feature configured to stop pivotal movement of the bolt assembly when it is in the engaged position and the disengaged position.

19. The releasable mount device of claim 18 wherein the feature is a protrusion in an aperture of the mount body containing the actuator.

20. The releasable mount device of claim 18 wherein the feature is a protrusion in an aperture of the mount body containing the bolt assembly.
